(19) United States
(12) Patent Application Publication
(10) Pub. No.: US 2014/0037812 A1
(43) Pub. Date: Feb. 6, 2014

(54) PROCESS FOR THE PRODUCTION OF A MEAT-LIKE PRODUCT

(71) Applicants: Ole Oxbøll, Slagelse (DK); Thomas Jørgensen, Kolding (DK)

(72) Inventors: Ole Oxbøll, Slagelse (DK); Thomas Jørgensen, Kolding (DK)

(73) Assignee: GEA FOOD SOLUTIONS BAKEL B.V., EN Bakel (NL)

(21) Appl. No.: 14/110,986

(22) PCT Filed: Apr. 4, 2012
(86) PCT No.: PCT/EP12/01485

§ 371 Date: Oct. 24, 2013

(30) Foreign Application Priority Data
Apr. 12, 2011 (EP) 11003064.0

(51) Int. Cl. A23L 1/317

(52) U.S. Cl. CPC A23L 1/3177
USPC 426/518; 426/520

(57) ABSTRACT

The present invention relates generally to food, pet food and feed products, particularly to the production of a meat product made from a minced and/or emulsified mixture, having a meatlike appearance and texture and products so produced.

The present invention relates generally to food products, particularly to the production of a meat product made from a minced and/or emulsified mixture, having a meat-like appearance and texture and products so produced.

Such processes are known from the state of the art, for example from EP 2 011 404 A1, WO 96/19120, WO 01/47370 A1 or WO 2008/151381. However, the processes described in these references are rather energy inefficient, space-consuming and/or do not lead to a sufficient product quality.

It was therefore the objective of the present invention, to provide an energy- and space-efficient process for the production of a meat-like product based on a minced and/or emulsified mixture.

The problem is attained with a process for the production of a fibrous solid meat product from a minced and/or emulsified mixture comprising protein, water and fat, whereas the mixture is supplied to a screw conveyor, in which it is heated to a temperature between 50 and 120° C.

The present invention relates to the production of a fibrous solid meat product form a minced and/or emulsified mixture comprising protein, water and fat. According to the present invention, this mixture is supplied to a screw conveyor, preferably at an initial temperature between −20 and +40° C. In this screw conveyor, the mixture is heated to 50-240° C., preferably 70-140° C. and thus becomes a solid meat-like product having a fibrous structure. During the heating of the product, no moisture is added. The resulting product is not damaged, particularly not overheated. The resulting product can be used for human consumption or as animal food.

This screw conveyor comprises a jacket and a helical screw which rotates within the jacket. The jacket preferably comprises a cylinder with, more preferably, a plain inner surface without a structure. The screw is arranged inside the jacket and the center axis of the screw and the center axis of the jacket are normally identical. The jacket preferably comprises an inner cylinder, which is heated directly or indirectly. The pressure of the product in the screw conveyor is not or at least not significantly increased during its flow from the inlet to the outlet of the screw conveyor, but only conveyed by the screw. The temperature rise of the product in the screw conveyor is achieved by heat transferred through the jacket and/or the through the surface of the screw. The main purpose of the screw is to remove, for example scrape, the product form the inner surface of the inner cylinder of the jacket of the screw conveyor and thus improve the heat transfer between the product and the heated inner cylinder of the screw conveyor. The flow rate of the product through the screw conveyor is determined for example by a pump, which is preferably arranged upstream from the screw conveyor and pumps the product into the screw conveyor. This pump is preferably a positive displacement pump. The rotation of the screw of the screw conveyor does not determine the flow rate of the product through the screw conveyor. The speed of rotation of the screw of the screw conveyor is preferably only altered to control the filling-level of the screw conveyor. By, for example, reducing the speed of rotation of the screw, the filling level of the screw conveyor can be increased at a given, constant flow rate, for example determined by a pump upstream from the screw conveyor. Preferably, the middle axis of the screw conveyor is arranged horizontally or at a slightly inclined angle, whereas the outlet of the screw conveyor is preferably at a higher level than the inlet of the screw conveyor.

The screw conveyor according to the present invention is not an extruder. An extruder comprises a screw pump and a die through which the product is pressed and thus formed and which acts as a counter pressure for the screw compressor. The screw pump comprises a rotor and a stator, which interact to build up the pressure of the product as it flows through the screw pump. In an extruder, the pressure of the product increases significantly from the inlet to the outlet of the screw pump. In an extruder, the temperature of the product is significantly increased by the friction between the product and the screw and/or the friction between the product and the stator and/or by the compression of the product which takes place in the screw pump. All the above mentioned features are not incorporated in a screw conveyor.

There is preferably a very small gap, preferably <2 mm, more preferably <1 mm between the inner circumference of the cylinder of the jacket and the outer diameter of the screw to continuously scrape the product from the inner diameter of the inner cylinder of the jacket of the screw conveyor. Preferably, the screw and/or the inner cylinder of the jacket of the screw conveyor are heated, more preferably to a temperature between 50-240° C., more preferably 80-120° C. Thus, the product is heated indirectly, via heat transfer from the screw and/or the jacket to the product. No significant temperature increase takes place due to the transportation of the product in the screw conveyor. The screw and the jacket can be heated to the same or different temperatures. The screw and/or the jacket can be, for example, heated by a circulating fluid and/or electrically, for example by induction heating. Preferably, the jacket and/or the screw are heated by steam, which flows through the jacket and/or the screw. Preferably, the jacket is insulated to avoid heat losses.

Preferably 2-4 kW are needed per ton of product to achieve the desired temperature rise. This is much more energy efficient than, for example an extruder, which consumes more than 15 kW for the same temperature rise.

The pressure which is provided at the inlet of the screw conveyor is preferably <3 bar. This pressure is only needed to fill the screw conveyor.

Preferably, the pressure level in the screw conveyor is controlled. This can be done, for example, by providing a pressure drop at the outlet or the screw conveyor and/or in the vicinity of the outlet of the screw conveyor.

The screw conveyor can comprise one or a multitude of screws. The screws can be intermeshing.

Preferably, the flight height of the screw is 1-20 mm, more preferably 2-8 mm and most preferably 3-6 mm. This assures a good efficient heat transfer without overheating the product and controlled shear forces during the heating of the product. Both preferably results in the desired texture of the resulting product.

In a preferred embodiment of the present invention, the screw conveyor comprises a multitude of zones, each operated at different temperatures.

Preferably, a vacuum is applied to the inventive process in order to avoid cavities in the resulting product and/or to influence the density, particularly the bulk density of the product. The vacuum is preferably applied to a pump, preferably a positive displacement pump, which pumps the product into the screw conveyor. Preferably, the vacuum is applied to the inlet of the pump. The degree of vacuum and/or its duration is preferably controlled. In a preferred embodiment, the bulk density of the resulting product is measured. Based on this measurement, the degree of vacuum and/or its duration is controlled.

The residence time of the product in the screw conveyor is preferably 1-300 sec, more preferably 2-200 seconds.

Preferably, a multitude of screw-conveyors are operated in parallel. The product resulting from these screw conveyor can be mixed or kept separate.

Preferably, the mixture is pumped into the screw compressor.

In a preferred embodiment, the mixture comprises 10-25 weight-% protein and 50-80 weight-% water.

In order to accomplish the minced or emulsified mixture, its ingredients are preferably processed in a grinder, mixer, blender and/or a cutter.

After and/or while the product leaves the screw conveyor, it is preferably cut in two dimensions, preferably both perpendicular to the transport direction of the screw. The resulting products can be irregular pieces and/or ropes. The cutting can be executed with a static and a moving, preferably rotating knife. The rotation knife can be driven by the screw of the screw conveyor or by a separate drive.

Prior to cutting, the product can be cooled but is preferably cut hot.

The entire process, particularly the temperature of the screw of the screw conveyor, the temperature of the jacket of the screw conveyor, the speed of rotation of the screw, the residence time of the mixture in the screw compressor, the pressure in the screw conveyor and/or the cutting process are particularly controlled by a PLC, for example a computer.

The resulting product is preferably transported away by a conveyor belt, whose speed is preferably automatically controlled, to a packaging station, where the product is packaged, for example into trays, preferably aluminum trays. A sauce or gravy can be added to the package, before it is closed. Before the product is packaged, it is preferably cooled, for example during transportation. The product is preferably packaged in a hermetically closed package, for example a can or a pouch or a tray with a lid. Prior and/or after inserting the product into the package, the package is preferably heat sterilized, for example heat treated to increase the shelf-life of the product.

Preferably, the inventive process comprises a quality-control measurement device, which for example measures the temperature, the moisture and/or mechanical properties of the resulting product. The signal of this device is used for documentation purposes and/or to reject the product, if needed.

Preferably, the inventive process comprises a density-, particularly bulk density-, control device, which measures the density, preferably the bulk density of the resulting product and controls the process accordingly. The signal of this device is preferably used for documentation purposes and/or to reject the product, if needed.

The inventive process is very energy efficient and has a very little space requirement.

Preferably, no mass is lost during the inventive process. The mass that enters the screw conveyor also exits the screw conveyor.

Another embodiment of the present invention is a product resulting from the inventive process.

The product can contain starch or be an all meat product

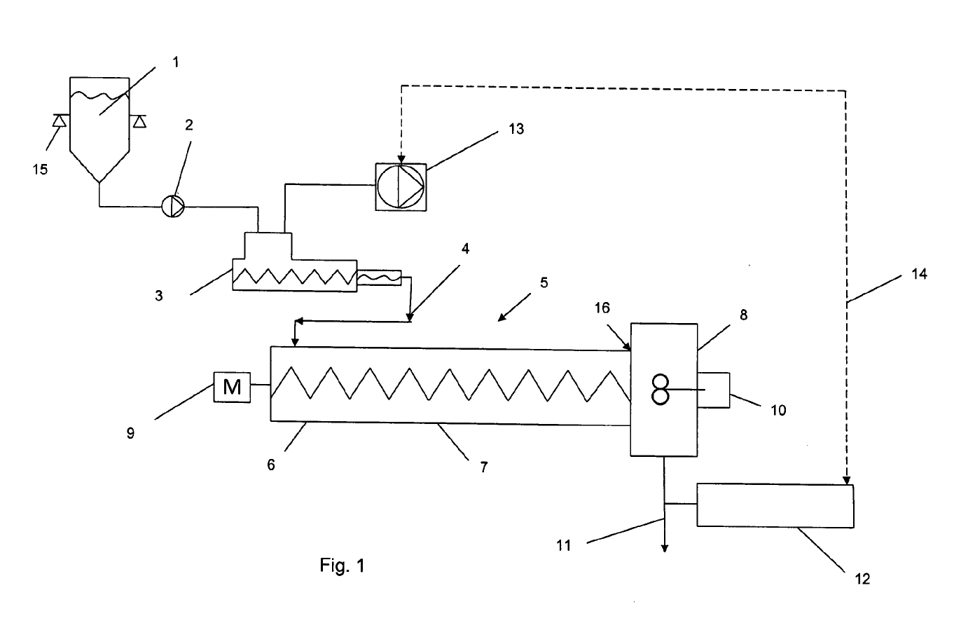

The invention is not explained according to the only FIG. 1. This explanation does not limit the scope of protection of the present invention.

In FIG. 1, the inventive process is depicted. The inventive process is utilized to convert a minced- and/or emulsified mixture comprising water protein, water and fat into a solid product with a meat-like appearance. The essential apparatus to execute the inventive process is a screw conveyor 5, which comprises a heated jacket 7, in the presence case a cylinder 7, and a conveyor screw 6 which rotates within the cylinder 7. The screw 6 is rotated by motor 9. Preferably, the speed of rotation of the screw 6 can be uttered. The outer diameter of screw 6 is designed such, that there is only a very small gap between the outer diameter of the screw 6 and the inner diameter of the cylinder 7. According to the present invention, the jacket, here the cylinder 7 and/or the screw 6 are heated, preferably by steam, more preferably up to a temperature between 50 and 240°. This heat is transferred to the product which heats the product to a temperature of 50-240° C. During this heating, the product is converted from a liquid into a solid, preferably fibrous, product. The product is pumped from a hopper 1, which is preferably placed on a load cell 15, into the screw conveyor 5 by a feed pump 3, in the present case a positive displacement pump. Between the hopper 1 and the feed pump 3 an additional pump 2 can be placed, which forces the product into the feed pump 3. Once the product has entered the screw conveyor 5 via its infeed 4, it is transported through the screw conveyor by the screw 6. However, during the transportation of the product from the infeed 4 to the outlet 16 of the screw conveyor, the pressure of the product, at least essentially, does not increase. The main purpose of the screw is to scrape the product from the inner sidewall of the cylinder 7 of the jacket, to avoid over-heating of the product and/or to attein a sufficient heat transfer between the inner diameter of the cylinder 7 and the product. The speed of rotation of the screw is preferably adjusted such, that the cylinder 7 is totally filled with the product from the inlet 4 to the outlet 16 of the screw conveyor. The residence time off the product in the screw conveyor is, at least mainly, determined by the pumping capacity of the infeed pump 3. The total in the screw conveyor is also determined by the infeed pump 3 and/or by a nozzle (not depicted) at the outlet of the screw conveyor, whose pressure drop essentially determines the pressure in the screw conveyor. The screw conveyor 5 does not comprise a die at its outlet. Furthermore, the screw is not designed to increase the pressure of the product from the inlet to the outlet. Furthermore, the inner diameter of the cylindrical sidewall is preferably plain. Thus, the screw conveyor is not comparable to an extruder. At the outlet 16 of the screw conveyor, a rotating knife 8 is positioned, which cuts the resulting, now solid product into small chunks. Preferably, the density, particularly the bulk density of the resulting product is measured by a sensor 12, which compares the measured density to a set value. In case this density is not as desired, for example in case the density is too low, a signal is sent via line 14 to a vacuum pump, which applies vacuum, preferably to the inlet of infeed pump 3 and/or to the screw conveyor in order to increase the density of the resulting product. The duration of the vacuum and/or the degree of vacuum is preferably controlled.

### LIST OF REFERENCE SIGNS

1 hopper

2 pump

3 feed pump

4 infeed to the screw conveyor

5 screw conveyor

6 screw

7 jacket, inner cylinder of the jacket

8 rotational knife

9 motor for rotating the screw 6

10 motor for rotating the knife 8

11 outlet

12 sensor, density sensor

13 compressor

14 signal

15 weight cell

16 outlet of the screw conveyor

1. A process for the production of a fibrous solid meat product form a minced and/or emulsified mixture comprising protein, water and fat, wherein the mixture is supplied to a screw conveyor, in which it is heated to a temperature between 50 and 120° C., wherein the screw conveyor is not an extruder.

2. The process according to claim 1, wherein the screw and/or the jacket of the screw conveyor, is heated, to a temperature between 50-220° C.

3. The process according to claim 1, wherein a flight height of the screw is 1-20 mm.

4. The process according to claim 1, wherein the screw conveyor comprises a multitude of zones, each comprising a different temperature.

5. The process according to claim 1, wherein speed of rotation of the screw is controlled.

6. The process according to claim 1, wherein vacuum is applied to the screw conveyor and/or a pump upstream from the screw conveyor.

7. The process according claim 1, wherein the residence time of the product in the screw conveyor 2 to 200 seconds

8. The process according to claim 1, wherein mixture is pumped into the screw compressor.

9. The process according to claim 1, wherein pressure in the screw compressor.

10. The process according to claim 1, wherein the mixture comprises 10-25 weight-% protein and 50-80 weight-% water.

11. The process according to claim 1, wherein product is cut downstream of the screw conveyor in two dimensions.

12. The process according to claim 2, wherein a flight height of the screw is 2-8 mm.

13. The process according to claim 12, wherein the screw conveyor comprises a multitude of zones, each comprising a different temperature.

14. The process according to claim 12, wherein speed of rotation of the screw is controlled.

15. The process according to claim 14, wherein vacuum is applied to the screw conveyor and/or a pump upstream from the screw conveyor.

16. The process according claim 13, wherein the residence time of he product in the screw conveyor 2 to 200 seconds.

17. The process according to claim 16, wherein mixture is pumped into the screw compressor.

18. The process according to claim 16, wherein pressure in the screw compressor is controlled in each zone.

19. The process according to claim 1, wherein the mixture comprises 10-25 weight-% protein and 50-80 weight-% water.

20. A process comprising:
a. supplying a minced and/or emulsified mixture including 10-25 weight-% protein, 50-80 weight-% water, and fat to a screw conveyor;
b. heating the screw conveyor to a temperature between 50° C. and 120° C., and wherein an inner cylinder of the screw conveyor is heated to a temperature between 70° C. and 120° C.;
c. controlling a speed of rotation of the screw conveyor;
d. applying vacuum to the screw conveyor and/or applying a pump upstream from the screw conveyor; and
e. cutting a product of the screw conveyor downstream of the screw conveyor
wherein the screw conveyor includes a multitude of zones and each of the multitude of zones are heated to a different temperature;
wherein a residence time of a product in the screw conveyor 2 seconds to 200 seconds;
wherein the screw conveyor has a flight height of 3 mm to 6 mm;
wherein the screw conveyor is not an extruder.
